(19) United States
(12) Patent Application Publication
(10) Pub. No.: US 2025/0066068 A1
(43) Pub. Date: Feb. 27, 2025

(54) CONTAINER BLANKS, METHODS OF FOLDING THE SAME, AND USES OF A CONTAINER THEREBY OBTAINED

(71) Applicant: The Procter & Gamble Company, Cincinnati, OH (US)

(72) Inventors: Guillaume Nicolas Louis BLOUET, Brussels (BE); Jan Dominiek VERBRUGGE, Oelegem (BE)

(21) Appl. No.: 18/811,077

(22) Filed: Aug. 21, 2024

(30) Foreign Application Priority Data
Aug. 23, 2023 (EP) 23193069.4

(51) Int. Cl. B65D 5/42; B31B 50/26; B31B 50/62; B31B 110/30; B31B 120/10; B65D 5/02

(52) U.S. Cl. CPC B65D 5/4266; B31B 50/26; B31B 50/624; B65D 5/0227; B31B 2110/30; B31B 2120/102; B31B 2241/00

(57) ABSTRACT

A container blank (100) containing: a main panel (102); a main flap (106) separated from the main panel (102) by a main crease line (108) parallel to a transversal direction (x); a secondary panel (112) separated from the main panel (102) by a longitudinal crease line (104); a secondary flap (116) separated from the secondary panel (112) by a secondary crease line (118) parallel to the transversal direction (x), the secondary flap (116, 616, 716) having a thickness (e); wherein the secondary crease line (118) is offset longitudinally with respect to the main crease line (108) of a distance (D1) comprised between 100% and 200% of the thickness (e) of the secondary flap (116), the main panel (102) containing a longitudinal free edge portion (103) adjacent to the secondary flap (116) and having a length (L1) corresponding to the distance (D1).

### BACKGROUND

This invention generally relates to container blanks for crafting a container. In a non-limiting example, the container blank is intended to be folded so as to form a container which can be filled with a detergent product. Such containers containing detergent products constitute consumer products that are present in consumer homes, in particular in rooms such as a kitchen, a laundry room or a bathroom. These locations tend to constitute a humid environment. It is important for the container to be configured so that it adequately protects the detergent product from degradation due to an excessive exposure, to excessive temperatures or to such moisture or humidity.

### BRIEF DESCRIPTION OF THE DRAWINGS

FIG. 1 illustrates a first example container blank.

FIG. 2 illustrates a second example container blank.

FIG. 3 illustrates a third example container blank.

FIG. 4 illustrates a fourth example container blank.

FIG. 5 illustrates a fifth example container blank.

FIG. 6 illustrates a sixth example container blank.

FIG. 7 illustrates a seventh example container blank.

FIG. 8 illustrates an eighth example container blank.

FIG. 9 illustrates a ninth example container blank.

FIG. 10 illustrates a tenth example container blank.

FIG. 11 illustrates a first example method.

FIGS. 12A-12B illustrate a second example method.

FIG. 13A-13C illustrate a third example method.

### DETAILED DESCRIPTION

Document DE 92 00 577 U1 shows a container blank for containing medical hygiene products. This container blank is not designed for containing a detergent product: detergent products are sensitive to humidity and to temperature. They should be contained in specifically designed containers, and in particular containers which may be properly scaled, for example to form a sift-proof container. While the containers are filled, transported, stored, or in use, they can be manipulated, and the container should ensure that no content exits the container. The specific offset between crease lines of the container blank of the present disclosure provides a substantial benefit over this known container blank in terms of reduced sifting and reduced moisture ingress.

Additionally, the amount of material that is to be used for manufacturing a container should be as low as possible for environmental reasons while simultaneously reliably shielding the detergent product from moisture. For environmental reasons also, it may be advantageous for a container to not contain small additional elements, such as clips, staples, tear strips, which separate from the container in use, and which render the recycling process cumbersome.

In other words, the container blank of the present disclosure uses a reduced amount of material while enabling to obtain a container avoiding or suppressing an undesired loss of content without compromission of the protection against extreme temperatures or against moisture ingress.

The present disclosure focuses on a container blank. A container blank should be understood as an intermediate product intended to ultimately form a container. A container blank (or die cut) is a substantially flat object that is specifically designed to be fed to a machine that can perform various operations, such as folding, gluing or the like, in order to obtain a container. A blank may be made of one piece or may comprise several pieces attached together. The container blank can be made from one of the material or layered materials discussed further below. A blank has a thickness that is substantially smaller than its overall width or length. The thickness may be homogeneous through-out the entirety of the blank or the thickness may vary.

The blank may be constituted of one or more panels and one or more flaps, separated from each other by crease lines. Crease lines should be understood as linear segments of the blank which have endured a creasing process, so as to offer well-defined folding lines. They facilitate the folding operation and enable to obtain a container with intended shape and function. When referring to the blank in this disclosure, and unless explicitly mentioned otherwise, a panel is generally intended to depict a portion of the blank that is delimited by at least two crease lines. A flap is, unless explicitly mentioned otherwise, generally intended to depict a portion of the blank that is delimited by a single crease line and that is connected to exactly one panel. When referring to the container obtainable by the container blank, a flap is a portion of the container that is hinged to another portion of the container at a folding line. The relative movement of the flap with respect to other portions may be partially or totally prevented by other flaps or by attachment of the flap to other portions of the container. In some examples, the container is made of corrugated material comprising flutes extending in the longitudinal direction. The crease lines separating a flap from a panel may extend perpendicularly to the orientation of the flutes. This may provide a memory effect for easing (un) folding the flap. The crease lines separating a panel from another panel may extend along the orientation of the flutes.

It should be understood that the blank may comprise one or more main panels, and one or more secondary panels, the one or more main panels being in some examples of greater dimension than the one or more secondary panels. In some examples, the main and secondary panels are intended to constitute the sidewalls of the resulting container.

In one example, the blank contains main flaps and secondary flaps. A main flap is to be understood as a flap connected to a main panel and a secondary flap as a flap connected to a secondary panel. A main flap is not necessarily of greater dimension than a secondary flap.

In some examples, the blank is provided with an auxiliary panel bearing at least one auxiliary flap. The auxiliary panel may have an auxiliary function, such as attaching together a main panel and a secondary panel.

In some examples, the panels and the flaps may have a generally rectangular shape. In some examples, at least some of the panels or of the flaps may have a generally square, polygonal, circular or ellipsoidal shape. In some examples, at least one of the panel or at least one of the flaps has a different width than the other panels and flaps.

In the present disclosure, a longitudinal direction is defined as extending parallel to the longest dimension (=length) of a main panel and a transversal direction is defined as extending parallel to the second longest dimension (=width) of a main panel. In one example, the longitudinal direction of the blank may correspond to a vertical direction of the resulting container when such container sits on its base for use.

In the present examples, a panel directly connected to a flap or to another panel is intended to mean that the panel is adjacent to the flap or other panel, and the panel is only separated from the flap or other panel by a crease line. In other words, no additional element of the container blank is interposed between the panel and the flap or other panel.

In the present disclosure, a free edge portion is intended to depict an edge of the container blank that delimits the material. A longitudinal free edge portion is a free edge portion extending substantially parallel to the longitudinal direction.

The crease lines of a first main flap and of a first secondary flap may be offset longitudinally with respect to one another. Such crease lines are arranged parallel to a transversal direction and are not colinear and therefore a distance between these two lines can be defined. This distance constitutes an offset between two lines arranged at distinct positions. For the resulting container, this offset results in folding lines of the container not being located at a same altitude. The offset is chosen to correspond to a value in relation to the thickness of the flaps, i.e., between 100% and 200% of the thickness of the secondary flap. The offset enables to obtain a sift-proof and robust container as the blank flaps and the blank panels fold and fit together. In some examples, the offset enables the flaps to be folded at a 90° angle so that the successive layers of flaps form a multi-layer sift-proof cover.

All or only some of the transversal crease lines may be offset. For instance, depending on the number of flaps that are to be folded (in the resulting container) between two adjacent crease lines, the offset may be a single offset or a double offset. A single offset may separate the crease lines by a distance of between 50% and 100% of the thickness of the flap, while a double offset may separate the crease lines by a distance of between 100% and 200% of the thickness of the flap. While some degree of offset may avoid introducing tension or deformation in a resulting container, limiting such offset may avoid or limit the possibility for the content to sift through overlapping flaps in a resulting container.

In some examples, the container comprises various precut lines arranged in one or more flaps. These precut lines can be lines of weakness (in comparison to the strength of material in their vicinity) intended to rupture when a sufficient shearing force is applied to the container. Precut lines can consist in a linear or a curved segment of a flap (or a panel) and can be formed by partially cutting the material. The partial cut may be in the thickness direction, i.e., a portion of the thickness of the flap/panel has been cut. The local thickness of the material is thus smaller at the precut line than around the precut line. Alternatively, the precut line can be formed by a dashed line of through-cuts, cutting intermittently through the entirety of the thickness of the flap/panel. A precut line may also comprise a combination of one or more partial cuts in the thickness direction and of one or more interrupted line of through cuts. Other techniques may be used to weaken the flap/panel in a precut line.

In some examples, the first main flap may have a through-opening. A through-opening is to be understood as a recess extending through the entirety of the thickness of the flap and surrounded by a closed contour of material of the flap (in contrast to a notch which would be only partially surrounded by material).

In some examples, the precut lines separate a proximal region of a flap from a distal region of a flap. Proximal regions are to be understood as a portion of the flap nearby or including a crease line. Distal regions of a flap are to be understood as a portion of the flap remote from the crease line and containing at least one free edge of the flap.

The resulting container, i.e., a container obtainable by the container blank of the present disclosure should be understood as an object housing a content, for example in a cavity of the container. The container together with its enclosed content can form a consumer product. The container facilitates protection, transport, storage, access and disposal of the consumer product.

A consumer product should in this disclosure be understood as a product which is provided, among others, to end consumers. Such consumer products may for example be available for purchase in supermarkets and end consumers may store such consumer products in their homes. Consumer products may be provided in large quantities and environmental concerns should thereby be taken into consideration when designing the products. Consumer products should also be designed taking transportation to a retail store into account. Consumer products should also be robust so as to withstand transportation as part of an e-commerce shipment. Consumer products should also be designed taking on the shelf storage in a retail store into account. Consumer products should also be designed taking transportation from a retail store to a consumer home into account. Consumer products should also be designed taking storage at a private end-consumer home into account. Consumer products should also be designed taking use of the consumer product at a private end consumer home into account. Consumer products should also be designed taking disposal into account.

The consumer product according to this disclosure comprises a detergent product. Detailed examples of the nature of the detergent product are given below.

In some examples, the container comprises a base. A base according to this disclosure should be understood as a wall on which the container may lie when placed on a supporting surface such as a shelf or a floor. The base may be made from a plurality of flaps folded with respect to the sidewalls such that those flaps forming the base lie in a substantially coplanar manner or in substantially parallel planes. In some examples, the base is flat. In some examples, the base is rectangular. In some examples, the base is oval or round. In some examples, the base has an embossed profile standing in or out in relief.

In the present disclosure, substantially should be understood as within 10%, preferably within 5%, of a measure concerned, taking for example the usual manufacturing tolerances into account. Two quantities are substantial equal to one another when they do not differ one from the other of more than 10%, preferably no more than 5%. A line is substantially oriented along a direction when said line does not depart from that direction of more than 5°, preferably no more than 2°, more preferably no more than 1°.

In the present disclosure, about should be understood as within 10%, preferably within 5%, of a measure concerned, taking for example the usual manufacturing tolerances into account.

In the present disclosure, the ordinal labels “first”, “second”, “third”, . . . “eighth” are used to distinguish features of the blank from each other. Hence, the first main panel is a panel that is distinct from the second main panel in the sense that they constitute two separate entities of the blank, although they may share similar dimensions or properties. A higher ordinal number (e.g., fourth) does not necessarily mean that similar features of lower ordinal number (e.g., third) are part of the example container blank: for instance, the container blank may comprise a fourth longitudinal crease line without containing a second or a third longitudinal crease line.

### DETAILED DESCRIPTION OF THE FIGURES

In some examples, the container blanks shown in the appended figures may form only a portion of a complete blank that would be used to build a container. The various elements of the different figures can be combined to form various shapes of containers. Similar numbers in the various figures are intended to depict similar elements of the blank. The container blank or part of it can be made of any suitable material. Examples of such materials are discussed in detail below. A coordinate system is introduced with axis x indicating a transversal direction and axis y indicating a longitudinal direction. As will be apparent in the figures, the longitudinal direction is the direction of greatest dimension of the main panel(s). In other examples not illustrated here but encompassed in the scope of this disclosure, the longitudinal direction may correspond to a shortest dimension of the main panel(s). As will be apparent, the crease lines connecting a panel to a flap extend parallel to the transversal direction whereas the crease lines separating a panel from another panel extend parallel to the longitudinal direction.

In the figures, the panels are represented as having a generally rectangular shape. However, as noted above, the shape of the panels may be of different nature. Also, the flaps are represented as being substantially rectangular or trapezoidal. These shapes are intended to present the various aspects of the present disclosure in a schematic way, for the sake of clarity. However, the person skilled in the art will know how to modify the general shapes of the panels and flaps without departing from the ambits of the disclosure. In particular, the orientations of the longitudinal and transversal directions may be appropriately altered if the shape of the panels or flaps are modified.

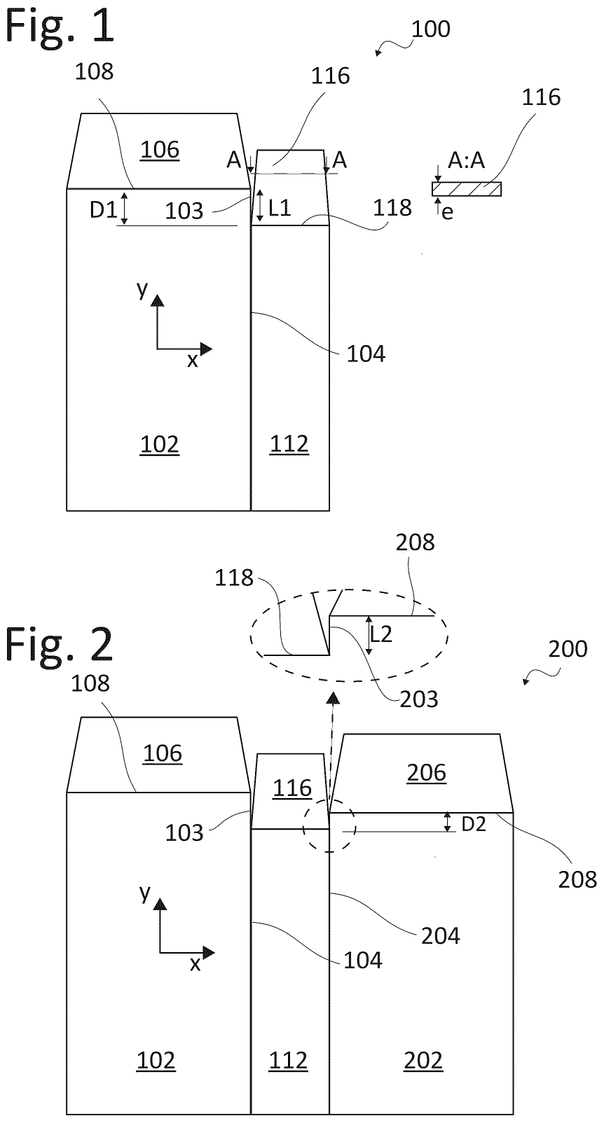

FIGS. 1 to 9 show a blank where there are flaps arranged only on one side of the panels. It should be noted that the container blanks 100-900 may be modified to have further flaps at the opposite side of the panels that are drawn. In some examples, the container blank is symmetric with respect to the transversal axis x.

FIG. 1 illustrates an example container blank 100 according to this description. The container blank 100 comprises a main panel 102 and a main flap 106 separated from the main panel 102 by a main crease line 108 along the transversal direction. The coordinate system indicates the transversal direction x and the longitudinal direction y and is arbitrarily positioned at the center of the main panel 102.

The blank 100 further comprises a secondary panel 112, directly connected to the main panel 102. A longitudinal crease line 104 separates the main panel 102 from the secondary panel 112. The secondary panel 112 is of a size that is smaller than the size of the main panel 102. In some examples, the transversal width of the secondary panel 112 is at least a third, and less than 100%, of the transversal width of the main panel 102. The main panel 102 may have a transversal width that is comprised between 15 and 60 cm, preferably between 18.5 cm and 28.4 cm. The secondary panel 112 may have a transversal width that is comprised between 5 and 25 cm, preferably between 6.2 and 14.5 cm. Both panels may have a (respective) height that is comprised between 20 cm and 70 cm, and preferably between 20.5 cm and 50 cm.

The secondary panel 112 bears a secondary flap 116, separated from the secondary panel 112 by a secondary crease line 118 along the transversal direction.

The main crease line 108 and the secondary crease line 118 are offset in the longitudinal direction y. The offset distance is shown with the label D1 on FIG. 1. The offset is arranged in such a direction that a longitudinal free edge portion 103 is formed on the main panel 102 (and not on the secondary panel 112). The longitudinal free edge portion has a length L1 that equates the distance D1. In some examples, the longitudinal length of the secondary panel 112 is smaller than the longitudinal length of the main panel 102.

The distance D1 is comprised between 100% and 200% of the thickness e (as shown in cross-section A: A) of the secondary flap 116. In some examples, D1 is comprised between 110% and 150% of the thickness c. The thickness e may be comprised between 0.5 mm and 6 mm, preferably between 1.5 mm and 4 mm. The distance D1 may be comprised between 0.52 mm and 11.4 mm, preferably between 2 and 4 mm.

This offset enables, once the flaps are folded, to render the container sift-proof. Without being bound by theory, this offset may also preserve an internal strain between the flaps which may become useful to facilitate the opening of the container, as the flaps will tend to open when a lock is released. As shown below, in some examples, the lock may be constituted of a tab releasably engaging a tab receptor. In some examples, the container is made of corrugated material comprising flutes extending in a longitudinal direction and the tab deforms perpendicularly to the main direction of the flutes. This may provide a memory effect for the deformation of the tab.

In the following description, the main panel 102 is a first main panel 102, the longitudinal free edge portion 103 is a first longitudinal free edge portion 103, the longitudinal crease line 104 is a first longitudinal crease line 104, the main flap 106 is a first main flap 106, the main crease line 108 is a first main crease line 108, the secondary panel 112 is a first secondary panel 112, the secondary flap 116 is a first secondary flap 116, the secondary crease line 118 is a first secondary crease line 118, the distance D1 is a first distance D1 and the length L1 is a first length L1.

FIG. 2 shows an example of a container blank 200. The container blank 200 may comprise the panels and flaps as presented in the previous figure. The container blank 200 further comprises a second main panel 202, directly connected to the first secondary panel 112, and separated therefrom by a second longitudinal crease line 204. The second main panel 202 bears a second main flap 206 directly connected to the second main panel 202 and separated therefrom by a second main crease line 208. The dimensions of the second main panel 202 can substantially equate those of the first main panel 102. In some examples, the dimensions of the second main flap 206 substantially equate the dimensions of the first main flap 106.

The distance D2 shows a longitudinal offset between the second main crease line 208 and the first secondary crease line 118. A second longitudinal free edge portion 203 of the second main panel 202 materializes the direction of this offset. The length L2 of the second longitudinal free edge portion 203 equates the distance D2. The distance D2 may be comprised between 50% and 100% of the thickness c (as shown FIG. 1) of the secondary flap 116. In some examples, D2 is comprised between 55% and 95% of the thickness c. As the blank is folded to form the container, the second main flap is intended to be folded on the secondary flap 116, and the first main flap 106 is intended to be folded on the second main flap 206. Hence, the distance D2 can be smaller than the distance D1, while still ensuring a sift-proof arrangement. In some examples, the distance D2 is about half of the distance D1. The thickness e may be comprised between 0.5 mm and 6 mm, preferably between 1.5 mm and 4 mm. The distance D2 may be comprised between 0.26 mm and 5.7 mm, preferably between 1 and 2.5 mm.

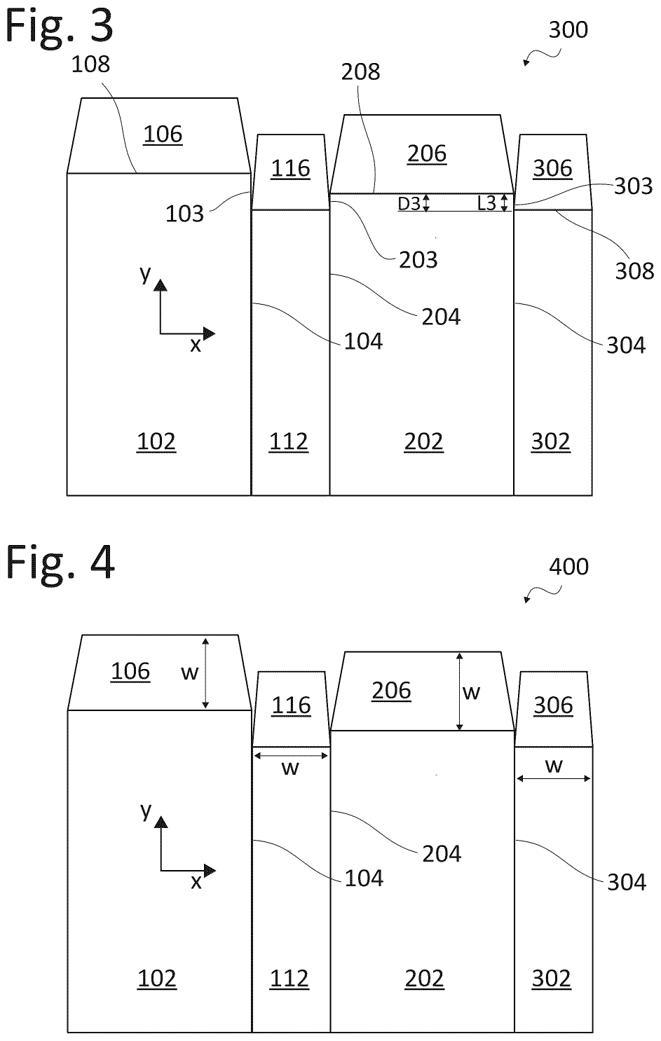

FIG. 3 shows an example container blank 300. The container blank 300 may comprise the panels and flaps as presented in the previous figures. The container blank 300 further comprises a second secondary panel 302, directly connected to the second main panel 202, and separated therefrom by a third longitudinal crease line 304. The second secondary panel 302 bears a second secondary flap 306 directly connected to the second secondary panel 302 and separated therefrom by a second secondary crease line 308. The dimensions of the second secondary panel 302 can substantially equate those of the first secondary panel 112. In some examples, the dimensions of the second secondary flap 306 substantially equate the dimensions of the first secondary flap 116.

The distance D3 shows a longitudinal offset between the second main crease line 208 and the second secondary crease line 308. A third longitudinal free edge portion 303 of the second main panel 202 materializes the direction of this offset. The length L3 of the third longitudinal free edge portion 303 equates the distance D3. The distance D3 may be comprised between 50% and 100% of the thickness e (as shown FIG. 1) of the secondary flap 116. In some examples, D3 is comprised between 55% and 95% of the thickness e. The thickness e may be comprised between 0.5 mm and 6 mm, preferably between 1.5 mm and 4 mm. The distance D2 may be comprised between 0.26 mm and 5.7 mm, preferably between 1 and 2.5 mm.

In some examples, the distance D2 is substantially equal to the distance D3.

FIG. 4 shows an example container blank 400. The container blank 400 may comprise the panels and flaps as presented in the previous figures. As shown in FIG. 4, in some examples, the longitudinal width w of the first main flap 106 and of the second main flap 206 may be equal and may equate the transversal width w of the first and/or of the second secondary panels 112, 302. In such an example, the four panels 102, 112, 202, 302 may form sidewalls of a container, defining an opening, and the main flaps 106, 206 may cover substantially the entirety of such an opening.

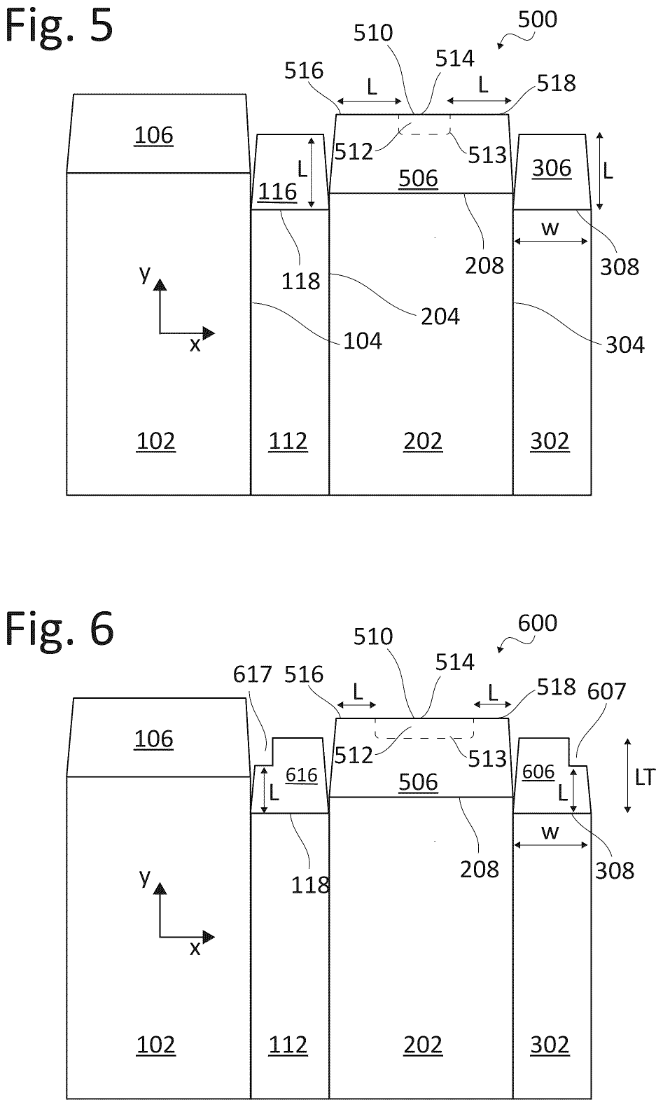

FIG. 5 shows an example container blank 500. The container blank 500 may comprise the panels and flaps as presented in the previous figures. FIG. 5 shows that the second main flap 506 may have a distal edge 510 opposite the second main panel 202. The distal edge 510 may be substantially parallel to the second main crease line 208. A distal region 512 of the second main flap 506 may be delimited by a precut line 513 and by the distal edge 510. The distal region 512 and the precut line 513 subdivide the distal edge 510 into a central section 514 and two lateral sections 516, 518 along the transversal direction. In some examples, the two lateral sections 516, 518 have the same length. In such examples, the length of the two lateral sections 516, 518 is equal to the longitudinal length of the secondary flaps 116, 306. In some examples, the two lateral sections 516, 518 have different lengths. In such examples, the length of the two lateral sections 516, 518 are different and are respectively equal to the longitudinal lengths of the secondary flaps 116, 306. Hence, when the secondary flaps 116, 306 are folded along the secondary crease lines 118, 308 and when the second main flap 506 is folded along the second main crease line 208, the secondary flaps 116, 306 do not overlap the distal region 512. The secondary flaps 116, 306 may form a tight arrangement if they are designed to be adjacent to the precut line 513.

FIG. 6 shows an example container blank 600 constituting an alternative design to the one of FIG. 5. The design of FIG. 6 may be preferred in particular for blanks of smaller dimensions, i.e., container blanks of dimensions situated in the lower half of the ranges discussed above in relation to FIG. 1. The container blank 600 may comprise the panels and flaps as presented in the previous figures. FIG. 6 shows that the secondary flaps 616, 606 may have respective notches 617, 607 such that an overall length LT of these flaps 616, 606 may be bigger than a corresponding length L of the two lateral sections 516, 518 but a shortest length at the location of the notches 617, 607 can be substantially equal to the corresponding length L of the two lateral sections 516, 518. In other examples not illustrated here, the lateral sections 516 and 518 may have different lengths, the notches 617 and 607 having respectively different dimensions matching the corresponding different lengths so as to avoid overlapping the distal region 512.

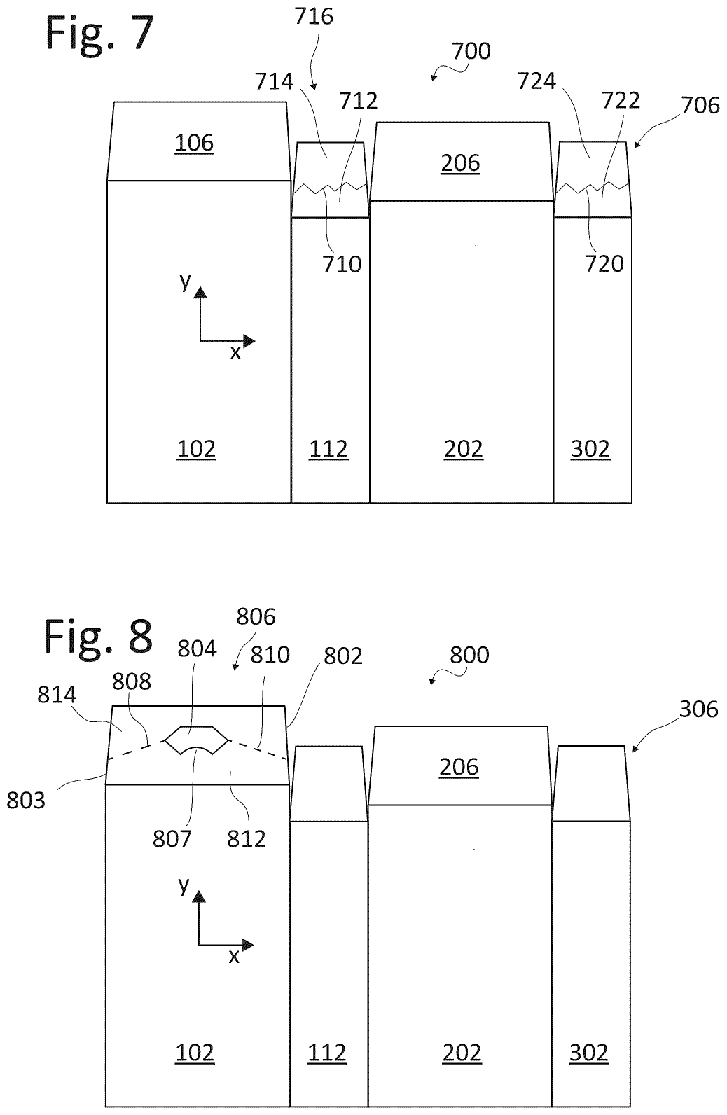

FIG. 7 shows an example container blank 700. The container blank 700 may comprise the panels and flaps as presented in the previous figures. FIG. 7 shows that the secondary flaps 716, 706 may comprise precut lines 710, 720 which divide the secondary flaps into a proximal region 712, 722 and a distal region 714, 724. The precut lines 710, 720 extend substantially transversally. In some embodiments, the distal regions 714, 724 can be provided with an adhesive layer so as to adhere to the second main flap 206, as the container blank is folded to form a container.

FIG. 8 shows an example container blank 800. The container blank 800 may comprise the panels and flaps as presented in the previous figures. FIG. 8 shows that the first main flap 806 may be provided with two lateral edges 802, 803, with a through-opening 804 and with two precut lines 808, 810 which connect the through-opening 804 to the lateral edges 802, 803 respectively. The precut lines 808, 810 may be substantially linear, may be slanted, and or may be curved. In some examples an edge of the through-opening 804 may form a tab 807 that an end user may pull to tear off the precut lines 808, 810. A proximal region 812 of the first main flap 806 can thus be separated from a distal region 814 of the first main flap 806.

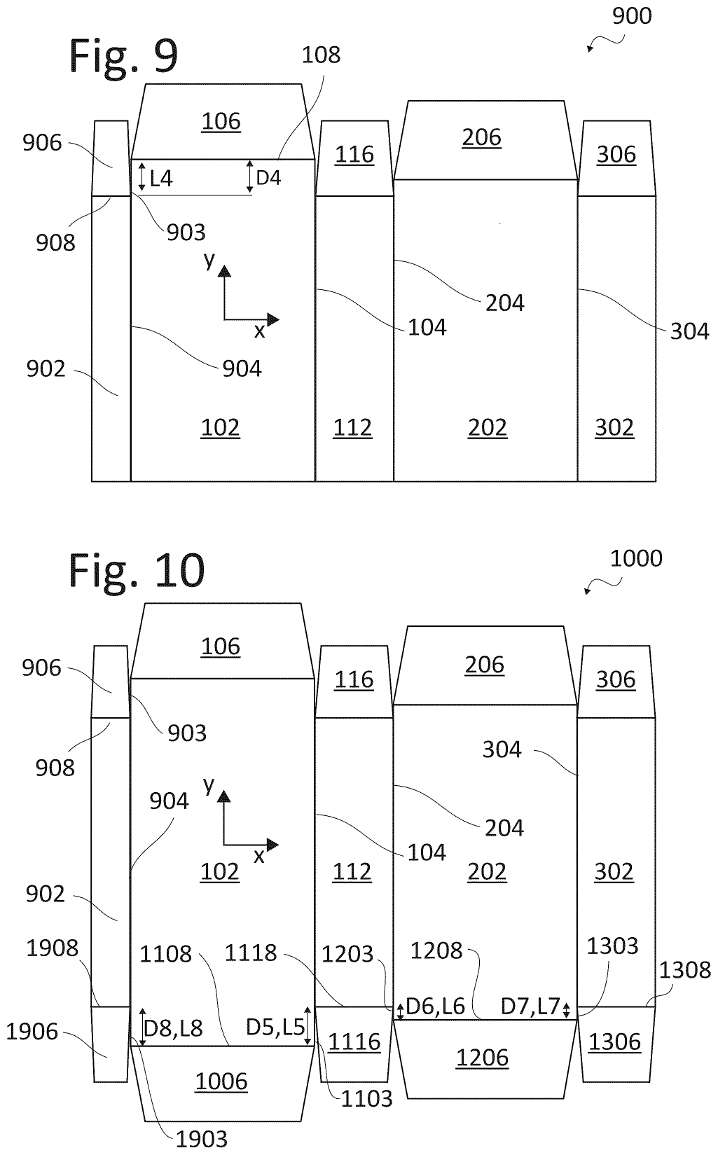

FIG. 9 shows an example container blank 900. The container blank 900 may comprise the panels and flaps as presented in the previous figures. FIG. 9 shows a container blank with an auxiliary panel 902 directly connected to the first main panel 102 through a fourth longitudinal crease line 904. In some examples, the first through fourth longitudinal crease lines 104, 204, 304, 904 can be intended to form the four vertical edges of a parallelepiped container. The auxiliary panel 902 can bear an auxiliary flap 906 separated from the auxiliary panel by an auxiliary crease line 908. The auxiliary crease line 908 can be offset from the first main crease line 108 by a fourth distance D4. A fourth longitudinal free edge portion 903 of the first main panel 102 can have a length L4 equal to the fourth distance D4. The distance D4 may be comprised between 100% and 200% of the thickness e (as shown FIG. 1) of the secondary flap 116. In some examples, D4 is comprised between 110% and 150% of the thickness e. In some examples, D4 is substantially equal to D1. The thickness e may be comprised between 0.5 mm and 6 mm, preferably between 1.5 mm and 4 mm. The distance D4 may be comprised between 0.52 mm and 11.4 mm, preferably between 2 and 4 mm.

The auxiliary panel 902 may have a transversal width that is substantially smaller than the width of the secondary panels 112, 302, for instance at least five times smaller. The longitudinal width of the auxiliary flap 906 may be substantially equal to the longitudinal width (L on FIG. 5, LT on FIG. 6) of the secondary flaps. The auxiliary flap may thus be long enough to create a tension (directly or indirectly) below the main and secondary flap(s). This will further improve the sift-proof property of the container and will help the opening of the container as it will create a vertical force assisting the flaps to open when a lock of the container is released. As shown below, in some examples, the lock may be constituted of a tab releasably engaging a tab receptor.

It is important to note that while, in the detailed examples, the panels 902, 102, 112, 202 and 302 follow each other along direction y, numerous other configurations may be provided, such as, for example, a configuration whereby panels 102, 112, 202, 302 and 902 may follow each other along direction y, or, for example, panels 112, 202, 302, 102 and 902 may follow each other along direction y.

FIG. 10 shows an example container blank 1000. The container blank 1000 may comprise the panels and flaps as presented in the previous FIG. 9. The container blank 1000 may comprise a third main flap 1006 connected to the first main panel 102 opposite the first main flap 106. A third main crease line 1108 separates the first main panel 102 from the third main flap 1006. The container blank 1000 may comprise a fourth main flap 1206 connected to the second main panel 202 opposite the second main flap 206. A fourth main crease line 1208 separates the second main panel 202 from the fourth main flap 1206. The container blank 1000 may comprise a third secondary flap 1116 connected to the first secondary panel 112 opposite the first secondary flap 116. A third secondary crease line 1118 separates the first secondary panel 112 from the third secondary flap 1116. The container blank 1000 may comprise a fourth secondary flap 1306 connected to the second secondary panel 302 opposite the second secondary flap 306. A fourth secondary crease line 1308 separates the second secondary panel 302 from the fourth secondary flap 1306. A second auxiliary flap 1906 may be provided opposite the first auxiliary flap 906. A second auxiliary crease line 1908 separates the auxiliary panel 902 from the second auxiliary flap 1906.

In some examples, the crease lines 1108, 1118, 1208, 1308, 1908 are all aligned, or at least the third and fourth main crease lines 1108, 1208 are aligned. In some examples, the crease lines 1108, 1118, 1208, 1308, 1908 are offset as shown on FIG. 10. A fifth longitudinal free edge portion 1103, a sixth longitudinal free edge portion 1203, a seventh longitudinal free edge portion 1303, and an eighth longitudinal free edge portion 1903, define the directions of these offsets. These longitudinal free edge portions have a respective length L5, L6, L7, L8 that respectively matches the fifth, sixth, seventh and eighth offset distances D5, D6, D7, D8 between two adjacent crease lines. In some examples, D6 is substantially equal to D7. In some examples, D5 is substantially equal to D8. In some examples, D6 and/or D7 is substantially equal to half of D5 or D8.

In some examples, the flaps 1006, 1116, 1206, 1306 and 1906 may be respectively symmetric to the flaps 106, 116, 206, 306 and 906. In some examples, the flaps 1006, 1116, 1206 and 1306 have similar features as those presented for the symmetrically located flaps 206, 306, 506, 606, 616, 706, 716 and 806 on FIGS. 4 to 8. Similarly, offset distances D5, D6, D7, D8 and lengths L5, L6, L7, L8 may correspond to respective offset distances D1, D2, D3, D4 and lengths L1, L2, L3, L4.

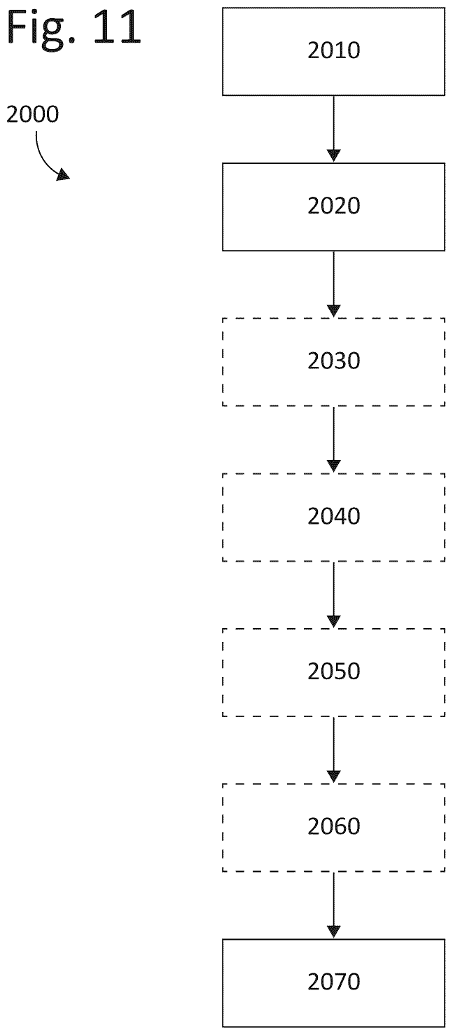

FIG. 11 illustrates an example of a method for obtaining a container from one of the container blanks 100-1000.

In step 2010, a container blank according to any of the previous examples is provided.

This step may comprise a sub-step where the panels are folded together along the longitudinal crease lines 104, 204, 304, 904. The auxiliary panel 902 may connect the first main panel 102 to the second secondary panel 306. To that end, glue or similar adhesive element can be applied to the auxiliary panel 902 prior to the panels being folded together along the longitudinal crease lines.

In step 2020, the secondary flap(s) 116, 306, 606, 706, 616, 716 are folded along the secondary crease line(s) 118, 308. The corresponding offset implies that the folded secondary flap would at least partially fill, with its thickness, the corresponding free edge portion, thereby avoiding generating or building excessive tension in a resulting container. The offsets and free edges portions hereby described indeed generate a volume in which the corresponding flap or flaps may be housed.

Steps 2030 to 2060 are optional, as they involve features of the container blank that are presented as optional in the examples above.

In step 2030, an adhesive element is applied on a distal region 714, 724 of the first and second secondary flaps. The adhesive element may be at least one of: glue, staple, adhesive tape, clips, etc. The proximal regions 712, 722 are left substantially free of adhesive element.

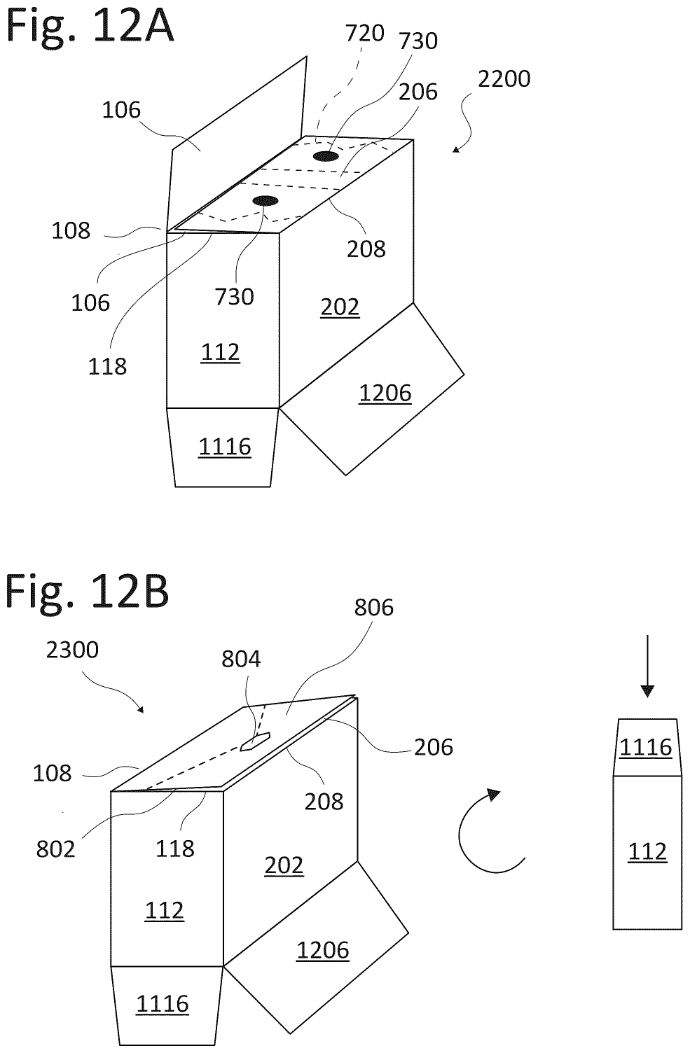

In step 2040, the second main flap 206, 506 is folded over the secondary flap(s) 116, 306, 606, 706, 616, 716. FIG. 12A shows a container being manufactured, where the second main flap has been folded over the secondary flaps. As an adhesive element 730 has been applied to the distal regions, the second main flap adheres to these distal regions.

Referring back to FIG. 11, in step 2050, an adhesive element is applied on a distal region 512 of the second main flap. In step 2060, an adhesive element is applied on a proximal region of the second main flap, the proximal region mirroring a distal region 814 of the first main flap delimited by precut lines 808; 810 and by a through-opening 804 of the first main flap.

In step 2070, the (first) main flap 106, 806 is folded down along the (first) main crease line 108, on the secondary flaps and optionally on the second main flap that has been folded over the secondary flaps. FIG. 12B shows a container being manufactured after the main flap 806 has been folded down.

FIG. 12B shows on the left-hand side a container partially manufactured and obtainable with a method as shown on FIG. 11. This container can be turned over as shown on the right-hand side. The container can then be filled with a content, such as for example one of the detergent compositions discussed below. The flaps 1906, 1116, 1206, 1306 may then be folded to close the container. Thus, the flaps 106, 116, 206, 306, 506, 606, 616, 706, 716, 806 constitute a base of the container while it is being filled. In some examples, the container is being filled in a position upside down compared to a position in which it will stand during use. This may for example permit providing a measuring scoop in the container, whereby the measuring scoop is dropped into an empty container prior to dropping the content of the container, the container being then offered to a user with the scoop presented on top of the content of the container. The container hereby provided may for example correspond to a container as described in one or more of the examples of the patent application EP23192988.6 filed on 23 Aug. 2023, in the name of the same Applicant and entitle “Consumer products and methods for operating the same” and herein incorporated by reference.

In some examples, the container is filled with the detergent composition, the filled detergent composition being in direct contact with the material forming the blanks hereby described, thereby avoiding the use of additional materials such as an insert. The blanks hereby described indeed permit, via the offset(s) and matching free edge(s) portion, to neatly fold the flaps, reducing or avoiding creating tension into the container structure, reducing or avoiding breakage at the crease lines or in the vicinity of the crease lines.

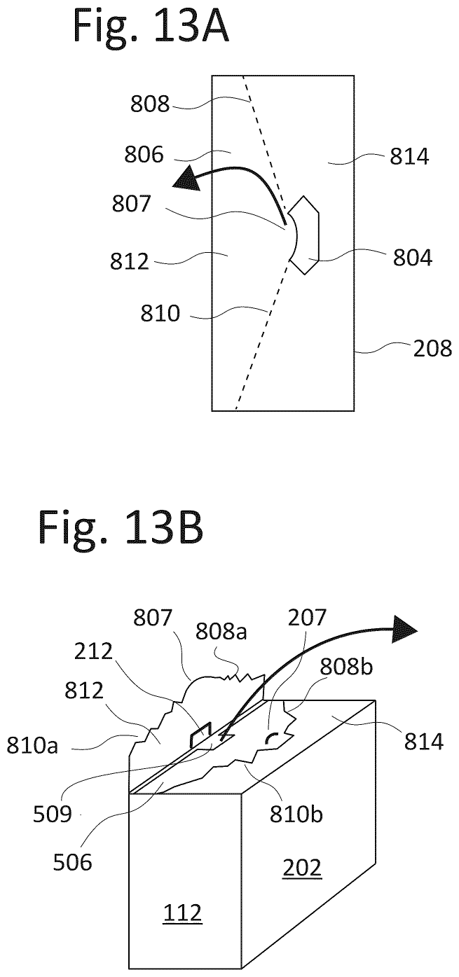

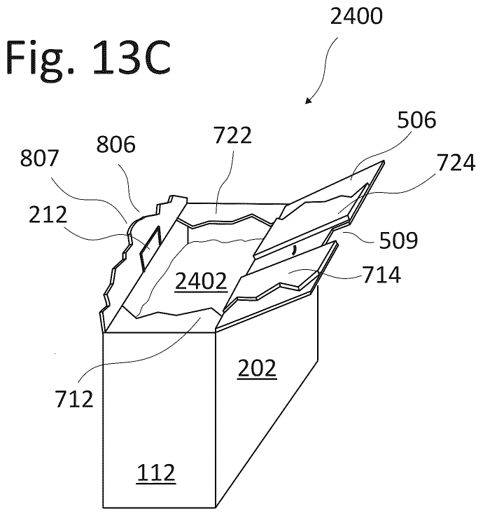

FIGS. 13A-13C show a method of opening the container. FIG. 13A shows a top view of an example of a container. In this example, the end user may pull a tab 807 in accordance with the arrow drawn on FIG. 13A. This action would tear off the precut lines 808, 810, the proximal region 812 of the first main flap 806 remaining attached to the first main panel (102 not visible on the left-hand side of the figure), while the distal region 814 adheres to the second main flap folded below the first main flap. In some examples, the container is made of corrugated material comprising flutes extending in a longitudinal direction and the tab deforms perpendicularly to the main direction of the flutes. This may provide a memory effect for the deformation of the tab.

FIG. 13B shows an example of a container after the first main flap has been open. Once the tab 807 has been pulled, the precut lines 808, 810 are separated as two pairs of mirroring teared-off edges 808a, 808b, 810a, 810b.

A tab receptor 207 provided on the second main flap has been revealed by the opening the first main flap. The tab receptor 207 may cooperate with the tab 807 for repeatably opening and closing the container.

In this example, a distal region 512 of the second main flap 506 has been teared off from the second main flap 506 and adheres to the proximal region 812 of the first main flap. A recess 509 results from this separation. The recess 509 can serve as a handle for the end user to open the second main flap 506.

Once the user pulls open the second main flap 506, optionally by pulling the recess 509, the container 2400 as shown on FIG. 13C is obtained. Simultaneously to pulling the second main flap 506, the distal regions 714, 724 of the secondary flaps which adhere to the second main flap 506 are teared off from the proximal regions 712, 722 of the secondary flaps, thereby offering a wide opening for the end user to access the content 2402 enclosed in the container.

### Material Constituting the Container

As detailed below, the container blank of this disclosure can be partially or totally made from a paper material such as a material selected from paperboard, cardboard, laminates comprising at least one paper board or cardboard layer. Paperboard or cardboard comprise cellulose fibre materials or a mixture thereof. The material used to make the container blank may comprise other ingredients, such as colorants, protective varnishes, surface enhancement coatings, barrier coatings, preservatives, recycled fibre materials, plasticisers, UV stabilizers, oxygen barriers, perfume barriers, and moisture barriers, or a mixture thereof. In some examples, in order to provide a desired tear resistance and strength, cellulose fibres length is in a range from 0.1 to 5 mm, preferably from 1 to 3 mm. In some examples, cellulose fibres are sourced from various sources such as virgin soft or hard woods, hemp, grass, corn, bagasse, sugarcane, bamboo and others, and/or from post producer or post-consumer recycled paper and cardboard. The container blank may comprise areas of external or internal printing. The container blank may be made for example by cardboard making. Suitable container manufacturing processes may include, but are not limited to, tube forming from a flat cardboard or paperboard sheet with a gluing step, folding, or a mixture thereof. The container blank may be opaque or may filter some specific wavelengths, for example to protect content from external light. In some examples the container blank is constructed at least in part and in some specific examples in its entirety from paper-based material. By paper-based material, we herein mean a material comprising paper. Without being bound by theory, ‘paper’ is to be understood as a material made from a cellulose-based pulp. Paperboard may be made from a paper-based material having a thickness and rigidity such that it does not collapse under its own weight. While paperboard should be understood as comprising a single layer of material, cardboard should be understood as comprising a plurality of paper-based material layers. In some examples, the paper-based material comprises paperboard, cardboard, or a mixture thereof, wherein preferably, cardboard comprises paperboard, corrugated fibre-board, or a mixture thereof. Corrugated fiber-board comprises a series of flutes. Each flute can be understood to be a channel. The flutes run parallel to one another, with the flute direction being the direction travelled along each channel. Further details of the material forming the container blank are given further below.

The paper-based material may be a laminate comprising paper, cardboard, or a mixture thereof, wherein in some examples, cardboard comprises paperboard, corrugated fiber-board, or a mixture thereof, and in some examples at least another material. In some examples, the at least another material comprises a plastic material. In some examples, the plastic material comprises polyethylene, more specifically Low-Density PolyEthylene (LDPE), polyethylene terephthalate, polypropylene, polyvinylalcohol or a mixture thereof. In some examples the plastic material comprises a copolymer from an ethylene starting monomer and vinyl alcohol, or EVOH. A barrier material may be used as the at least another material. The barrier material may be a biaxially orientated polypropylene, a metallised polyethylene terephthalate, or a mixture thereof. The at least another material may comprise a wax, a cellulose material, polyvinylalcohol, silica dioxide, casein-based materials, or a mixture thereof. In some examples, the paper-based laminate comprises more than 50%, preferably more than 85%, and more preferably more than 95% by weight of the paper-based laminate of fiber-based materials. In some examples, the barrier material may comprise plastic material having a thickness of between 10 micron and 60 microns. In some examples, the barrier material may comprise plastic material having a thickness of between 10 micron and 35 microns. The paper-based material may be a laminate.

In some examples, the internal surface of a container (i.e., one side of the blank) comprises paperboard, cardboard, or a mixture thereof, wherein, in specific examples, cardboard comprises paperboard, corrugated fiber-board and lamination of polyethylene, especially LDPE, or a mixture thereof, and, in some examples, the external surface of the container (i.e., the other side of the blank) comprises the at least another material. Alternatively, the at least another material might also be laminated in-between two paper-based material layers such as the paperboard or cardboard layers as per this disclosure. Without wishing to be bound by theory this at least another material might act as a barrier for leaked liquid absorbed by the paper-based material facing the inner side of the container, to prevent or reduce a contaminating flow through a wall of the container. Other structures may be found efficient to avoid leakage from the content or to protect the content from external fluids, for example from a shower, a sink, or by handling the container with wet hands. Contamination of a wall of the container might be unsightly to consumers or may contaminate the storage area.

In some examples, the container blank is made of a paper-based material comprising the at least another material laminated in between two corrugated fiberboard layers.

In some examples, the material used for the container blank comprises a core cardboard flute material sandwiched between two plain cardboard (or paperboard) layers and polyethylene laminate.

A paperboard or cardboard layer according to this disclosure may be made from or may comprise recycled material or recycled cellulose fibres. One side of the container blank may comprise a coating or a varnish. Such a coating or varnish can help making a board repellent to water or help protecting a content such as an enclosed detergent composition from UV light. The coating or varnish could also help protecting the external surface of the container from being contaminated by the content, for example an enclosed detergent composition, for example if leakage of a water-soluble unit dose detergent enclosing a liquid detergent composition would occur.

A coating or vanish on the internal surface can help to prevent the content to stick to the inner surface or prevent migration of inks, colorants, perfumes, non-ionics, oils, greases and other ingredients from the content into the board or inks or additives from the board onto the content. In some examples detergent resistant varnishes or coatings can be applied on areas exposed to the contents.

As noted above, the container blank may indeed be made from paper or cardboard material, in particular rigid cardboard material, flexible cardboard material or a mixture thereof. In some examples, the material forming the container blank has a wall thickness of more than 220 microns and of less than 3 mm. In some examples, the material forming the container blank has a thickness of more than 1 mm and of less than 2 mm. In some examples, the material forming the container is folded on itself, for example to reinforce parts of or the whole of the box or the cover. The container blank may be made from paper materials, bio-based material, bamboo fibres, cellulose fibres, cellulose based or fibre-based materials, or a mixture thereof. The container blank may be made from materials comprising recycled materials, for example recycled cellulose fibre-based materials. In some examples, in order to facilitate opening, the cover may be entirely separated from the box when open, and the cover weighs less than 200 g, preferably less than 100 g, even more preferably less than 80 g, and more than 10 g, more preferably more than 30 g, even more preferably more than 40 g, in order to obtain a sufficiently robust cover structure.

In some examples, the container blank is made of a corrugated cardboard layer, the corrugated cardboard layer comprising flutes, the flutes preferably running parallel to the longitudinal direction y. This direction may be the vertical direction for the sidewalls of the resulting container. The flutes reinforce the strength of the container blank.

### Laundry Detergent Composition

In some examples the container blank is intended to form a container suitable for containing a detergent product. A detergent product comprises a detergent composition. The detergent composition may be a laundry detergent composition, an automatic dishwashing composition, a hard surface cleaning composition, or a combination thereof. The detergent composition may comprise a solid, a liquid or a mixture thereof. The term liquid includes a gel, a solution, a dispersion, a paste, or a mixture thereof. The solid may be a powder. By powder we herein mean that the detergent composition may comprise solid particulates or may be a single homogenous solid. In some examples, the powder detergent composition comprises particles. This means that the powder detergent composition comprises individual solid particles as opposed to the solid being a single homogenous solid. The particles may be free-flowing or may be compacted. A laundry detergent composition can be used in a fabric hand wash operation or may be used in an automatic machine fabric wash operation, for example in an automatic machine fabric wash operation.

The laundry detergent composition may comprise the solid linear alkyl benzene sulphonate anionic detersive surfactant particle.

Typically, the laundry detergent composition is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellac particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds suppressors; and any combination thereof.

Suitable laundry detergent compositions may have a low buffering capacity. Such laundry detergent compositions typically have a reserve alkalinity to pH 9.5 of less than 5.0 gNaOH/100 g. These low buffered laundry detergent compositions typically comprise low levels of carbonate salt.

### Detersive Surfactant:

Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

### Anionic Detersive Surfactant:

Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

### Non-Ionic Detersive Surfactant:

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable non-ionic detersive surfactants include secondary alcohol-based detersive surfactants.

### Cationic Detersive Surfactant:

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula: (R)(R₁)(R₂)(R₃)N⁺X⁻
wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

### Zwitterionic Detersive Surfactant:

Suitable zwitterionic detersive surfactants include amine oxides and/or betaines.

### Polymer:

Suitable polymers include carboxylate polymers, soil release polymers, anti-redeposition polymers, cellulosic polymers, care polymers and any combination thereof.

### Carboxylate Polymer:

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

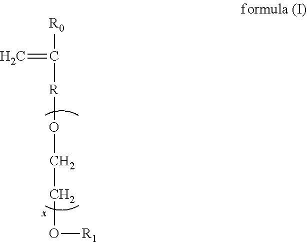

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

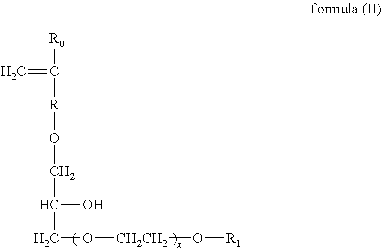

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

### Soil Release Polymer:

The composition may comprise a soil release polymer. A suitable soil release polymer has a structure as defined by one of the following structures (I), (II) or (III):

—[(OCHR¹—CHR²)ₐ—O—OC—Ar—CO-]_{d} (I)

—[(OCHR³—CHR⁴)_{b}—O—OC-sAr—CO-]ₑ (II)

—[(OCHR⁵—CHR⁶)_{c}—OR⁷]_{f} (III)

wherein: a, b and c are from 1 to 200; d, e and f are from 1 to 50; Ar is a 1,4-substituted phenylene; sAr is 1,3-substituted phenylene substituted in position 5 with SO₃Me; Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof; R¹, R², R³, R⁴, R⁵ and R⁶ are independently selected from H or C₁-C₁₈ n- or iso-alkyl; and R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g., TexCare® SRN240 and TexCare® SRA300. Other suitable soil release polymers are sold by Solvay under the Repel-o-Tex® series of polymers, e.g., Repel-o-Tex® SF2 and Repel-o-Tex® Crystal.

### Anti-Redeposition Polymer:

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO 08/007320 A1.

A suitable polyethylene glycol polymer is Sokalan HP22.

### Cellulosic Polymer:

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g., as described in WO 09/154933 A1.

### Care Polymers:

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

### Bleach:

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

### Source of Hydrogen Peroxide:

Suitable sources of hydrogen peroxide include sodium perborate and/or sodium percarbonate.

### Bleach Activator:

Suitable bleach activators include tetra acetyl ethylene diamine and/or alkyl oxybenzene sulphonate.

### Bleach Catalyst:

The composition may comprise a bleach catalyst. Suitable bleach catalysts include oxaziridinium bleach catalysts, transition metal bleach catalysts, especially manganese and iron bleach catalysts. A suitable bleach catalyst has a structure corresponding to general formula below:

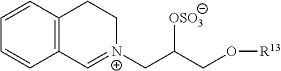

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

### Pre-Formed Peracid:

Suitable pre-form peracids include phthalimido-peroxycaproic acid.

### Enzymes:

Suitable enzymes include lipases, proteases, cellulases, amylases and any combination thereof.

### Protease:

Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz PR series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D) all from Henkel/Kemira; and KAP (Bacillus alkalophilus subtilisin with mutations A230V+S256G+S259N) from Kao.

A suitable protease is described in WO 11/140316 A1 and WO 11/072117 A1.

### Amylase:

Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO 06/002643 A1.

### Cellulase:

Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO 07/144857 A1 and WO 10/056652 A1.

### Lipase:

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g., such as those described in WO 06/090335 A1 and WO 13/116261 A1. In one aspect, the lipase is a first-wash lipase, preferably a variant of the wild-type lipase from Thermomyces lanuginosus comprising T231R and/or N233R mutations.

Preferred lipases include those sold under the tradenames Lipex®, Lipolex® and Lipoclean® by Novozymes, Bagsvaerd, Denmark.

Other suitable lipases include: Liprl 139, e.g., as described in WO 2013/171241 A1; and TfuLip2, e.g., as described in WO 2011/084412 A1 and WO 2013/033318 A1.

### Other Enzymes:

Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

### Zeolite Builder:

The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

### Phosphate Builder:

The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

### Carbonate Salt:

The composition may comprise carbonate salt. The composition may comprise from 0 wt % to 10 wt % carbonate salt, or to 5 wt % carbonate salt. The composition may even be substantially free of carbonate salt; substantially free means “no deliberately added”. Suitable carbonate salts include sodium carbonate and sodium bicarbonate.

### Silicate Salt:

The composition may comprise silicate salt. The composition may comprise from 0 wt % to 10 wt % silicate salt, or to 5 wt % silicate salt. A preferred silicate salt is sodium silicate, especially preferred are sodium silicates having a Na₂O:SiO₂ ratio of from 1.0 to 2.8, preferably from 1.6 to 2.0.

### Sulphate Salt:

A suitable sulphate salt is sodium sulphate.

### Brightener:

Suitable fluorescent brighteners include: di-styryl biphenyl compounds, e.g., Tinopal® CBS—X, di-amino stilbene di-sulfonic acid compounds, e.g., Tinopal® DMS pure Xtra and Blankophor® HRH, and Pyrazoline compounds, e.g., Blankophor® SN, and coumarin compounds, e.g., Tinopal® SWN.

Preferred brighteners are: sodium 2 (4-styryl-3-sulfophenyl)-2H-napthol [1,2-d]triazole, disodium 4,4′-bis{[(4-anilino-6-(N methyl-N-2 hydroxyethyl)amino 1,3,5-triazin-2-yl)]; amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfostyryl) biphenyl. A suitable fluorescent brightener is C.I. Fluorescent Brightener 260, which may be used in its beta or alpha crystalline forms, or a mixture of these forms.

### Chelant:

The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

### Hueing Agent:

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO 2014/089386 A1.

Suitable hueing agents include phthalocyanine and azo dye conjugates, such as described in WO 2009/069077 A1.

Suitable hueing agents may be alkoxylated. Such alkoxylated compounds may be produced by organic synthesis that may produce a mixture of molecules having different degrees of alkoxylation. Such mixtures may be used directly to provide the hueing agent or may undergo a purification step to increase the proportion of the target molecule. Suitable hueing agents include alkoxylated bis-azo dyes, such as described in WO 2012/054835 A1, and/or alkoxylated thiophene azo dyes, such as described in WO 2008/087497 A1 and WO2012/166768 A1.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077 A1.

### Dye Transfer Inhibitors:

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP—K15 and K30 (Ashland), Sokalan® HP165, HP50, HP53, HP59, HP56K, HP56, HP66 (BASF), Chromabond® S-400, S403E and S-100 (Ashland).

### Perfume:

Suitable perfumes comprise perfume materials selected from the group: (a) perfume materials having a C log P of less than 3.0 and a boiling point of less than 250° C. (quadrant 1 perfume materials); (b) perfume materials having a C log P of less than 3.0 and a boiling point of 250° C. or greater (quadrant 2 perfume materials); (c) perfume materials having a C log P of 3.0 or greater and a boiling point of less than 250° C. (quadrant 3 perfume materials); (d) perfume materials having a C log P of 3.0 or greater and a boiling point of 250° C. or greater (quadrant 4 perfume materials); and (c) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO 2009/101593 A1.

### Silicone:

Suitable silicones include polydimethylsiloxane and amino-silicones. Suitable silicones are described in WO 05075616 A1.

### Process for Making the Solid Composition:

Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO 2009/158162 A1.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449 A1.

It may be preferred for a gas, such as air, to be introduced into the spray-drying process after the step of forming the aqueous slurry, such as described in WO 2013/181205 A1.

It may be preferred for any inorganic ingredients, such as sodium sulphate and sodium carbonate, if present in the aqueous slurry mixture, to be micronized to a small particle size such as described in WO 2012/134969 A1.

Typically, a suitable agglomeration process comprises the step of contacting a detersive ingredient, such as a detersive surfactant, e.g., linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

### Method of Laundering Fabric:

The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### Water-Soluble Unit Dose Article

The detergent may be in the form of water-soluble unit doses articles comprising a water-soluble fibrous non-woven sheet and a granular laundry detergent composition. The fibrous non-woven sheet and the granular laundry detergent composition are described in more detail below.

The water-soluble fibrous non-woven sheet is shaped to form a sealed internal compartment, wherein the granular laundry detergent composition is comprised within said internal compartment.

The unit dose article may comprise a first fibrous non-woven sheet and a second water-soluble fibrous non-woven sheet sealed to one another such to define the internal compartment. The water-soluble unit dose article is constructed such that the granular detergent composition does not leak out of the compartment during storage. However, upon addition of the water-soluble unit dose article to water, the water-soluble non-woven fibrous sheet dissolves and releases the contents of the internal compartment into the wash liquor.

The compartment should be understood as meaning a closed internal space within the unit dose article, which holds the granular detergent composition. During manufacture, a first water-soluble fibrous non-woven sheet may be shaped to comprise an open compartment into which the detergent composition is added. A second water-soluble fibrous non-woven sheet may then be laid over the first sheet in such an orientation as to close the opening of the compartment. The first and second sheets are then sealed together along a seal region.

Alternatively, a single water-soluble fibrous non-woven may be shaped into an open container. The granular laundry detergent composition may then be filled into the open container and then the open container sealed to close it.

The unit dose article may comprise more than one compartment, at least two compartments, or even at least three compartments. The compartments may be positioned in a side-by-side orientation, i.e., one orientated next to the other. Alternatively, one compartment may be completely enclosed within another compartment.

When the unit dose article comprises at least two compartments, one of the compartments may be smaller than the other compartment.

Each compartment may comprise the same or different compositions.

### Water-Soluble Fibrous Non-Woven Sheet

The water-soluble unit dose article may comprise a water-soluble fibrous non-woven sheet. The water-soluble fibrous non-woven sheet comprises a plurality of fibres. Preferably, the fibres are inter-entangled fibres in the form of a fibrous structure.

The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibres comprise polyvinyl alcohol polymer. Preferably, the fibres comprise between 50% and 98%, preferably between 65% and 97%, more preferably between 80% and 96%, even more preferably between 88% and 96% by weight of the fibre of polyvinyl alcohol.

The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25 mPas, most preferably from 10 to 20 mPas, wherein the viscosity is measured as a 4% aqueous solution in demineralized water at 20° C.

In some examples the container blank may be of a size that is such that the resulting container may comprise between 1 and 80 water-soluble unit dose articles, between 1 and 60 water-soluble unit dose articles, between 1 and 40 water-soluble unit dose articles, or between 1 and 20 water-soluble unit dose articles. The capacity of the container may be comprised between 500 ml and 5000 ml, in some examples between 800 ml and 4000 ml.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container blank comprising:
a main panel;
a main flap directly connected to the main panel and separated from the main panel by a main crease line parallel to a transversal direction;
a secondary panel directly connected to the main panel and separated from the main panel by a longitudinal crease line parallel to a longitudinal direction;
a secondary flap directly connected to the secondary panel and separated from the secondary panel by a secondary crease line parallel to the transversal direction, the secondary flap having a thickness;
wherein the secondary crease line is offset longitudinally with respect to the main crease line of a distance comprised between about 100% and about 200% of the thickness of the secondary flap, the main panel comprising a longitudinal free edge portion adjacent to the secondary flap and having a length corresponding to the distance.

2. The container blank according to claim 1, wherein the main panel is a first main panel, the longitudinal crease line is a first longitudinal crease line, the main flap is a first main flap, the main crease line is a first main crease line, the longitudinal free edge portion is a first longitudinal free edge portion, the distance is a first distance and the length is a first length, the container blank further comprising:
a second main panel, directly connected to the secondary panel and separated from the secondary panel by a second longitudinal crease line parallel to the longitudinal direction; and
a second main flap directly connected to the second main panel and separated from the second main panel by a second main crease line parallel to a transversal direction,
wherein the secondary crease line is offset longitudinally with respect to the second main crease line of a second distance comprised between about 50% and about 100% of the thickness of the secondary flap, the second main panel comprising a second longitudinal free edge portion adjacent to the secondary panel and having a second length corresponding to the second distance.

3. The container blank according to claim 2, wherein the secondary panel is a first secondary panel, the secondary flap is a first secondary flap, and the secondary crease line is a first secondary crease line, the container blank further comprising:
a second secondary panel directly connected to the second main panel and separated from the second main panel by a third longitudinal crease line parallel to the longitudinal direction; and
a second secondary flap directly connected to the second secondary panel and separated from the second secondary panel by a second secondary crease line parallel to the transversal direction, the second secondary flap having a thickness,
wherein the second secondary crease line is offset longitudinally with respect to the second main crease line of a third distance comprised between about 50% and about 100% of the thickness of the second secondary flap, the second main panel comprising a third longitudinal free edge portion adjacent to the second secondary flap and having a third length corresponding to the third distance.

4. The container blank according to claim 3, wherein the third distance is substantially equal to the second distance.

5. The container blank according to claim 4, wherein the first and second main flaps have a same longitudinal width, and wherein the first and second secondary flaps have a transversal width that is substantially equal to the same longitudinal width of the first and second main flaps.

6. The container blank according to claim 5, wherein the first and second secondary flaps have a longitudinal width, wherein the second main flap comprises a distal edge opposite the second main crease line, the second main flap further comprising a distal region delimited by a precut line and by the distal edge, the distal region dividing the distal edge into three sections among which two lateral sections having a substantially identical transversal width that is substantially equal to the longitudinal width of the first and second secondary flaps.

7. The container blank according to claim 6, wherein the first and second secondary flaps comprise a respective distal corner notch of a shape that mirrors a portion of the precut line adjacent the distal edge of the second main panel.

8. The container blank according to claim 7, wherein the first and second secondary flaps each comprises a precut line extending substantially parallel to the transversal direction.

9. The container blank according to claim 8, wherein the first main flap comprises two lateral edges along the longitudinal direction, a through opening and two precut lines extending from the through-opening to a respective one of the two lateral edges.

10. The container blank according to claim 8, wherein the main panel is a first main panel, and the longitudinal crease line is a first longitudinal crease line, the container blank further comprising:
an auxiliary panel directly connected to the first main panel and separated from the first main panel by a fourth longitudinal crease line parallel to the longitudinal direction;
an auxiliary flap directly connected to the auxiliary panel and separated from the auxiliary panel by an auxiliary crease line parallel to the transversal direction, the auxiliary flap having a thickness;
wherein the auxiliary crease line is offset longitudinally with respect to the first main crease line of a fourth distance comprised between 100% and 200% of the thickness of the auxiliary flap, the first main panel comprising a fourth longitudinal free edge portion adjacent to the auxiliary flap and having a fourth length corresponding to the fourth distance.

11. The container blank according to claim 10, wherein the auxiliary flap is a first auxiliary flap, the container blank further comprising:
a third main flap directly connected to the first main panel and separated from the first main panel by a third main crease line parallel to a transversal direction;
a fourth main flap directly connected to the second main panel and separated from the second main panel by a fourth main crease line parallel to a transversal direction;
a third secondary flap directly connected to the first secondary panel and separated from the first secondary panel by a third secondary crease line parallel to the transversal direction, the third secondary flap having a thickness, wherein the third secondary crease line is offset longitudinally with respect to the third main crease line of a fifth distance comprised between about 100% and about 200% of the thickness of the third secondary flap, the first main panel comprising a fifth longitudinal free edge portion adjacent to the third secondary flap and having a fifth length corresponding to the fifth distance, and wherein the third secondary crease line is offset longitudinally with respect to the fourth main crease line of a sixth distance comprised between about 50% and about 100% of the thickness of the third secondary flap, the second main panel comprising a sixth longitudinal free edge portion adjacent to the third secondary flap and having a sixth length corresponding to the sixth distance;
a fourth secondary flap directly connected to the second secondary panel and separated from the second secondary panel by a fourth secondary crease line parallel to the transversal direction, the fourth secondary flap having a thickness, wherein the fourth secondary crease line is offset longitudinally with respect to the fourth main crease line of a seventh distance comprised between about 50% and about 100% of the thickness of the fourth secondary flap, the second main panel comprising a seventh longitudinal free edge portion adjacent to the fourth secondary flap and having a seventh length corresponding to the seventh distance; and
a second auxiliary flap directly connected to the auxiliary panel and separated from the auxiliary panel by a second auxiliary crease line parallel to the transversal direction, the second auxiliary flap having a thickness, wherein the second auxiliary crease line is offset longitudinally with respect to the third main crease line of an eighth distance comprised between about 100% and about 200% of the thickness of the second auxiliary flap, the first main panel comprising an eighth longitudinal free edge portion adjacent to the second auxiliary flap and having an eighth length corresponding to the eighth distance.

12. A method of folding a container comprising, in that order:
providing a container blank according to claim 1;
folding the secondary flap(s) along the secondary crease line(s);
folding the main flap(s) along the main crease line(s) and over the secondary flap(s).

13. A method of folding a container comprising, in that order:
providing a container blank according to claim 9;
folding the secondary flap(s) along the secondary crease line(s);
folding the main flap(s) along the main crease line(s) and over the secondary flap(s);
folding the second main flap over the first and second secondary flaps; and folding the first main flap over the second main flap.

14. A method according to claim 13, further comprising at least one of the following steps:
before folding the second main flap over the first and second secondary flaps, applying an adhesive element on a distal region of the first and second secondary flaps;
before folding the first main flap over the second main flap, applying an adhesive element on a distal region of the second main flap; and
before folding the first main flap over the second main flap, applying an adhesive element on a proximal region of second main flap, the proximal region mirroring a distal region of the first main flap delimited by precut lines and by a through-opening of the first main flap.
